(19) United States
(12) Patent Application Publication
(10) Pub. No.: US 2009/0268743 A1
(43) Pub. Date: Oct. 29, 2009

(54) Data transmission bridge device and control chip thereof for transmitting data

(76) Inventors: Chi-Tung Chang, Taipei (TW); Shih-Min Lan, Taipei (TW); Jia-Lung Wang, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/153,629

(22) Filed: May 22, 2008

(30) Foreign Application Priority Data
Apr. 28, 2008 (TW) 97115553

(51) Int. Cl. H04L 12/28

(52) U.S. Cl. 370/401

(57) ABSTRACT

A data transmission bridge device for transmitting data that adheres to USB specification for transmitting data and includes: a first connecting interface, a second connecting interface, and a control chip. The first connecting interface is used for connecting a first host device, and the second connecting interface is used for connecting a second host device or a slave device. The control chip connects the first connecting interface and the second connecting interface, and further includes two transmission paths. The control chip detects which device is connecting to the second connecting interface, and switch to select one of the two transmission paths for transmitting data between the first connecting interface and the second connecting interface. Therefore, the present invention can achieve the purpose that the host device can bridge and transmit data with any other device conveniently.

### BACKGROUND OF THE INVENTION

1. Field of the Invention

The present invention is related to a bridge device for transmitting data; and more particular to a data transmission bridge device and control chip thereof for transmitting data that adopts USB specification, and can utilize switching to bridge between two host devices for transmitting data.

2. Description of Related Art

Due to rapid technological development, the availability and usability of computer has increased accordingly. As a result, currently the majority of information (including video/audio, communication, and text document) can all be processed and produced by a computer, thus, the number of data file a user might save on a computer also increases.

With the increase of data files, by direct relation, the transmission of data becomes a common user action. And in the field of long distance data transfer, the most common practice is through internet connection to achieve the objective of data transmission. On the other hand for short distance data transfer or for data transfer in close physical proximity between two computer hosts, not only can an area network be set up for transmitting data, but also the major methods listed below are available:
1) An internet cable jumper connection method to directly connect two computer hosts. However in this method, user must separately prepare and maintain an internet jumper connection cable.
2) A short RF (radio frequency) method for transmission, for example: Bluetooth, infrared, etc. However in this method, both computer host must support and include RF transmission module, and must each establish confirmation settings, before data transfer can occur.
3) Through an external storage device, such as: thumb drive, portable hard drive, and similar device to indirectly facilitate data transfer between the two computer hosts. But this method has to be preformed separately on the two host computers and includes actions such as connecting external storage device to one computer host, copying file, detaching external storage device, connecting external storage device to another computer host, pasting file, and other various actions in order to complete data transfer, so that the data transfer efficiency is low.

However, regarding the above mentioned short range data transfer methods between computer hosts, although the 3^{rd} data transfer method has a low efficiency, but this method is also more commonly used by users. The reason is that portable storage device preserve data equally well when compared to the other two methods, but also has the advantage of being portable, furthermore because most of the portable storage device adhere to USB specification, so that it is useable simply by plug and play, so that users does not have to perform any extra setting to achieve connection.

Therefore, to design a bridge device for transmitting data unites the advantages of the above described transfer methods and avoids limitations, so that users can conveniently and efficiently proceed to transfer data between two computer host in short range. This is an area of research that is worth developing.

### SUMMARY OF THE INVENTION

As described above, the present invention intends to solve the technical limitation of the prior art, by designing a data transmission bridge device and control chip thereof for transmitting data between two nearby hosts; wherein the device would automatically detect the connecting device type and accordingly switch between different transmission paths, which would not only allow for support of data transfer between a host device and a slave device, but also can directly support data transfer between two host devices, and because the present invention device is designed to adhere to USB specification, so it is suitable for simple “plug and play”. Thus, the objective of conveniently bridging between a host device and any other device for data transfer is achieved. Further more, because the two connected devices would be transferring data directly, it will attend high transfer efficiency.

In order to achieve the object described supra, a solution is proposed according to the present invention, by providing a data transmission bridge device for transmitting data, which adopts USB specification for data transfer; which includes: a first connection interface, a second connection interface, and a control chip. Wherein, the first connection interface is for connecting to a first host device, and the second connection interface is for connecting to a second host device or a slave device. Also, the control chip connects with the first connection interface and the second connection interface, and furthermore includes two transmission paths; the control chip is for detecting the device connected with the second connection interface, and accordingly decide on one of the two transmission paths to use for the data transmission between the first connection interface and the second connection interface.

In order to achieve the object described supra, a solution is proposed according to the present invention, by providing a control chip for a data transmission bridge device for transmitting data, the bridge device include a first connection interface and a second connection interface, and the control chip includes: a first USB controller, a second USB controller, a bypass circuit unit, a detection unit, and a CPU. Wherein, the first USB controller connects to the first connection interface, and connects with the first host device through the first connection interface for data transmission. The second USB controller connects with the first USB controller and the second connection interface, and when the second connection interface is connected to a second host device, the second USB controller would also connect with the second host device through the second connection interface, thus forming a bridge for data transfer between the second host device and the first USB controller. The bypass circuit unit connects with the second connection interface, and when the second connection interface connects with a slave device, the bypass circuit unit will directly connect the first USB controller and the second connection interface, in order to provide host-slave operation between the first host device and the slave device. Furthermore, the detection unit will automatically operate to switch between a virtual host state and a virtual slave state, wherein the states are used to determine the type of device connected with the second connection interface, and a detection signal is produced accordingly, and the detection signal will be received by the CPU, and the CPU will accordingly control the second USB controller (host to host data transfer) or the bypass circuit unit (host to slave data transfer) for the appropriate operation.

In order to allow further understandings of the features and technical contents provided by the present invention, references are made to the following detailed descriptions and appended drawings; wherein the appended drawings are merely employed to present the references and illustrations of the present invention, not for imposing any restriction thereon.

### BRIEF DESCRIPTION OF THE DRAWINGS

FIG. 1 shows an embodiment of a schematic diagram for a data transmission bridge device and control chip thereof for transmitting data according to the present invention;

FIG. 2 shows an embodiment of a circuit diagram for a data transmission bridge device and control chip thereof for transmitting data according to the present invention;

FIG. 3 shows a first embodiment of a structural representation for a data transmission bridge device and control chip thereof for transmitting data according to the present invention;

FIG. 4 shows a second embodiment of a structural representation for a data transmission bridge device for transmitting data according to the present invention;

FIG. 5 shows an embodiment of a schematic diagram for a control chip for a data transmission bridge device for transmitting data according to the present invention;

FIG. 6 shows a method flow chart for a data transmission bridge device and control chip thereof for transmitting data according to the present invention;

### DETAILED DESCRIPTION OF THE PREFERRED EMBODIMENTS

The present Invention designed a data transmission bridge device for transmitting data between two devices (host-host or host-slave) through simple hardware structure, the main feature is the provision of two different transmission paths, so that by automatically detecting the type of device connected (host or slave) the present invention can switch to the proper transmission path, thus not only can host-slave operation between the host device and the slave device be supported, but direct bridging between two host device for data transfer is also possible. Further more the present invention adheres to USB specification by design, so that “plug and play” works properly. Thus the goal of allowing users to conveniently bridge between a host device and any other device (host or slave) for data transfer is achieved.

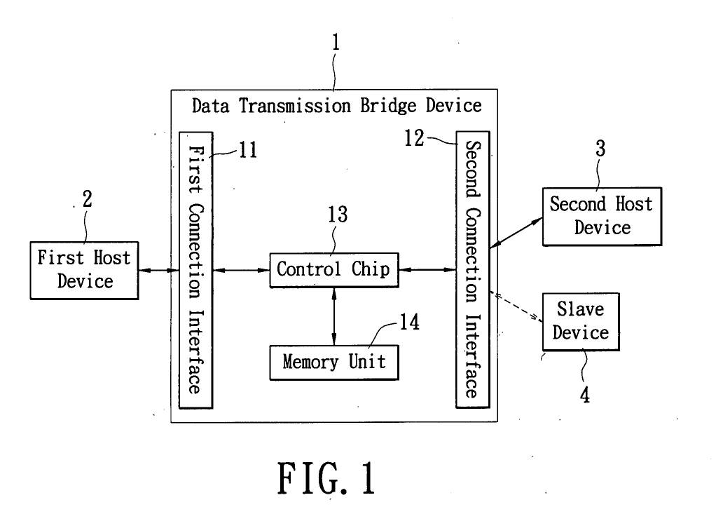

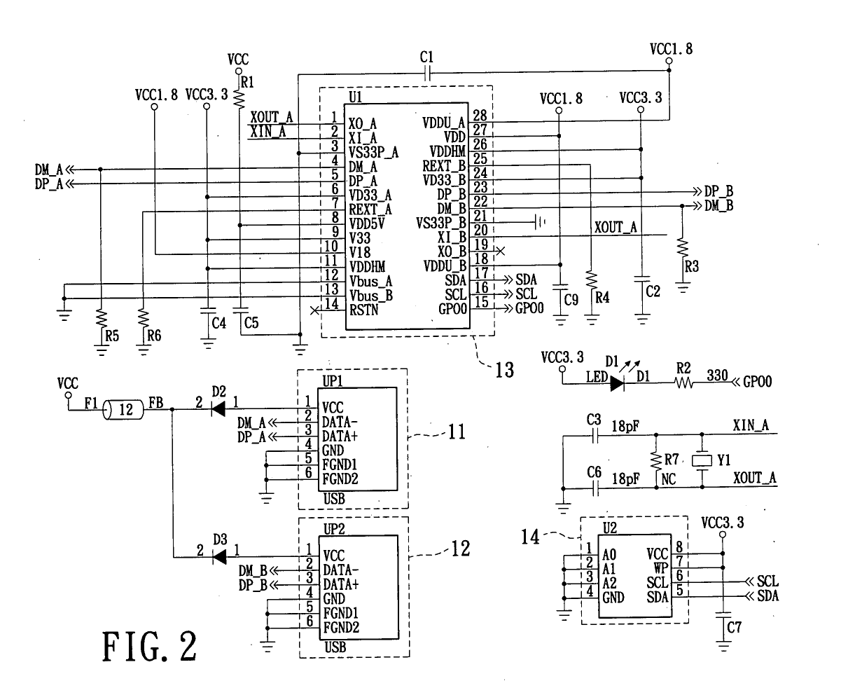

Please reference FIG. 1 and FIG. 2 in conjunction, which respectively shows an embodiment of a schematic circuit diagram for a data transmission bridge device and control chip thereof for transmitting data according to the present invention. As the figures show, the present embodiment provides a data transmission bridge device 1, which includes: a first connection interface 11, a second connection interface 12, a control chip 13, and a memory unit 14. Therein, the first connection interface 11 is for connecting to a first host device 2, and the second connection interface 12 is for connecting to a second host device 3 or a slave device 4.

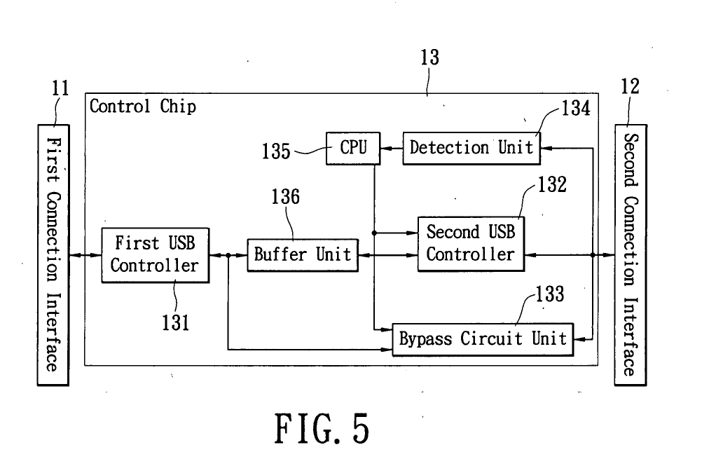

Control chip 13 connects the first connection interface 11 and the second connection interface 12, and the control chip 13 includes two transmission paths (FIG. 5: first path is the bridge transmission path which spans first connection interface 11, first USB controller 131, buffer unit 136, second USB controller 132, and second connection interface 12. The second path is the bypass path which spans first connection interface 11, first USB controller 131, bypass circuit unit 133, and second connection interface 12), specifically the control chip 13 is for detecting the device currently connected with the second connection interface 12, and according to the detection decide by switching to one of the two transmission paths to use for the data transmission between the first connection interface 11 and the second connection interface 12. Due to the fact that the present embodiment adheres to the USB specification, so the data transmission bridge device 1 must be designed based on a device class of USB, so that the data transmission bridge device 1 of the present embodiment can successfully support the bridging of the first host device 2 to the second host device 3 for transfer, therefore the control chip 13 of the data transmission bridge device 1 is designed based on a “user defined class” specified by Microsoft™, wherein the “user defined class” defines the connection protocol between two devices.

Furthermore, the above mentioned two transmission paths included in control chip 13 can be a bridge transmission path or a bypass path. The control chip 13 will automatically and periodically switch the second connection interface 12 to a virtual host state and a virtual slave state, wherein the states are used to determine whether the type of device connected with the second connection interface 12 is the second host device 3 or the slave device 4, so that the control chip 13 can respectively switch to the bridge transmission path or the bypass path.

For those skilled in the art of USB devices it is common knowledge that normally when a USB device is connected (i.e. a host-slave device connection), the associated slave device produces an inquire signal to the associated host device, and the connection is established once the host device has responded to the inquire signal. Therefore, in the present embodiment, when the first connection interface 11 is connected to the first host device 2, the control chip 13 will produce an inquire signal to the first host device 2 and wait for the first host device 2 to response, then the control chip will complete the connection between the first connection interface 11 and the first host device 2.

Similarly, when a current user is connecting the second host device 3 with the second connection interface 12, and the control chip 13 is switched to the virtual slave device state for the second connection interface 12, there will also be an inquire signal produced by the control chip 13 to the second host device 3, then once the second host device 3 responses, by the response confirmation can be made that the device connected to the second connection interface 12 is also a host, so that the control chip 13 will switch the transmission path to the bridge transmission path, in order to successfully complete the bridging between the first host device 2 and the second host device 3, so that data transfer can proceed between the two host devices.

On the other hand, when a user connects a slave device 4 to the second connection interface 12 (as suppose to the host device 3 as described above), and the control chip 13 is switched to the virtual host state for the second connection interface 12, the control chip 13 will determine if it has received a inquire signal produced by the slave device 4, and if such an inquire signal is received, then the device currently connected to the second interface 12 is determined to be a slave device, so the control chip 13 will switch the transmission path to the bypass path. Then the data transmission bridge device 1 merely acts with intermediate transmission function (similar to the commonly known USB HUB function), thus the present invention can directly provide host-slave operation between the first host device 2 and the slave device 4.

Lastly, the memory unit 14 of data transmission bridge device 1 is connected with the control chip 13, used for saving the required program or data needed by the control chip 13 while operating. In practical design, the memory unit 14 can be combined within the control chip 13. The present embodiment disclosed a structure of a data transmission bridge device 1 which by automatic detection switching can achieve the support of host-slave operation of a host device to a slave device, and also support the bridging of transmission between two host devices.

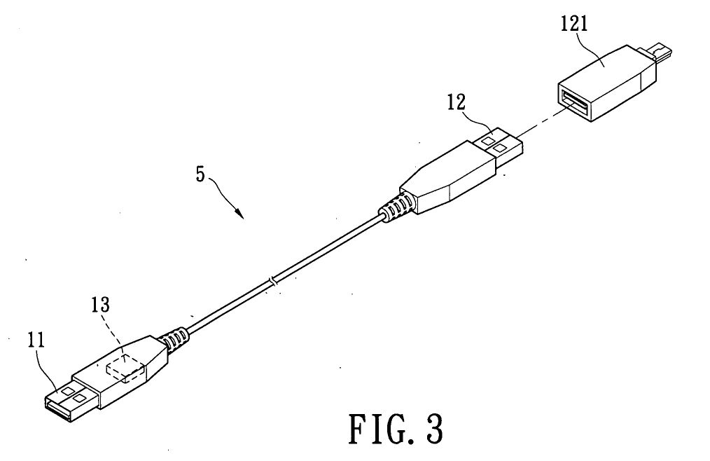

Please reference FIG. 3, which shows a first embodiment of a structural representation for a data transmission bridge device and control chip thereof for transmitting data according to the present invention. Due to the simple structure of the present invention, as shown by FIG. 3, the data transmission bridge device 1 of the present embodiment can be designed as a USB bridge transmission line 5, wherein the first connection interface 11 and the second connection interface 12 utilizes A-Type male connector design of USB specification, in order to respectively connect with the first host device 2 and the second host device 3. Additionally, if the second connection interface 12 needs to connect to a slave device 4 (which normally has a B-Type female connector of USB specification), then an adapter 121 can be further attached to transform the connector type of the second connection interface 12, so that the required B-Type male connector of USB specification can be available. Thus, a user would only need one USB bridge transmission line 5 for connection between a normal host device and slave device 4 and for their associated host-slave operation, furthermore the bridging for data transmission between first host device 2 and the second host device 3 can also achieved.

Of course, the connector type of the second connection interface 12 (A-Type male connector) is not limited to what is shown in the present embodiment. In practical design, the second connection interface 12 can also directly adopt an A-Type male connector and a B-Type male connector of USB specification to achieve dual connector type design. Or, the second connection interface 12 can also adopt a B-Type male connector, then pair with an adapter to acquire an A-Type male connector of USB specification. Further, other combinations and other connector types are too numerous to list, but those connector types covered under USB specification is all within the scope of the present invention.

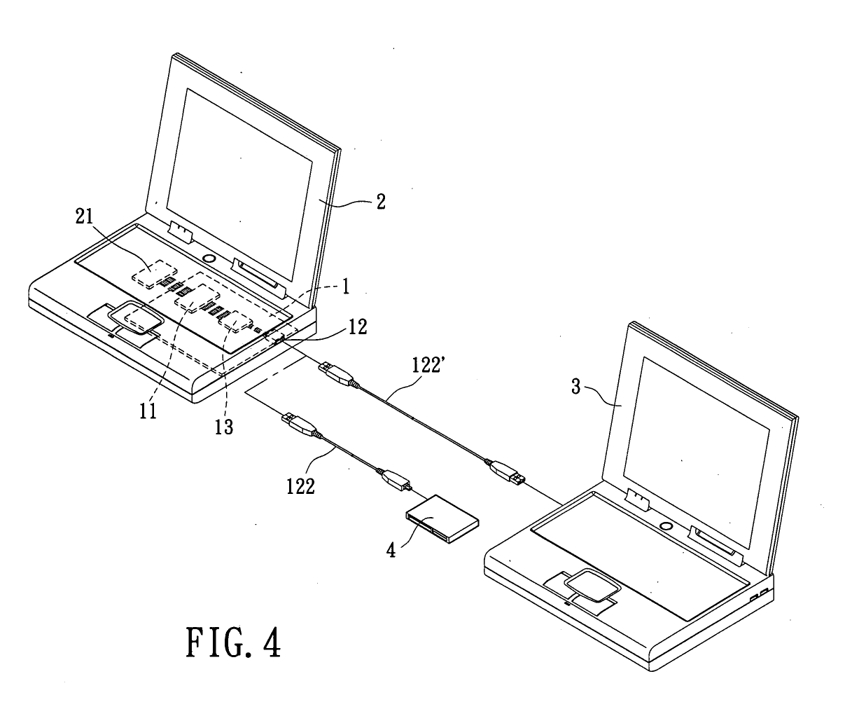

Please refer to FIG. 4, which shows a second embodiment of a structural representation for a data transmission bridge device for transmitting data according to the present invention. The data transmission bridge device 1 of the second embodiment differs in practical form from the first embodiment, wherein the second embodiment build the data transmission bridge device 1 directly within a first host device 2 (such as a notebook computer), and the first connection interface 11 is internally and directly connected with the host processor unit 21 of the first host device 2. In other words, the first connection interface 11 is permanently attached to the first host device 2.

The second connection interface 12 of FIG. 4 is designed to have the same type of USB connector that is normally provided by common notebook computers (A-Type female connector of the USB specification). So that the second connection interface 12 can in turn connect to a slave device 4 (i.e. a card reader) through transmission extension cable 122, or connect to a second host device 3 through transmission extension cable 122′, wherein the transmission extension cable 122 and 122′ only has to be a simple USB transmission cable. Thus, when a user is operating the first host device 2 disclosed by the present embodiment, connection to other devices can be made through the second connection interface 12, which not only can connect with the slave device 4 that is commonly used, but can also connect with a second host device 3, for direct data transmission between the two host devices.

In order to further explain the technique and content of the present invention in detail, please reference the explanation regarding the embodiment below.

Please reference FIG. 5, which shows an embodiment of a schematic diagram for a control chip of a data transmission bridge device used for transmitting data according to the present invention. As the figure shows, the present embodiment provides a control chip 13 for a data transmission bridge device 1, which includes: a first USB controller 131, a second USB controller 132, a bypass circuit unit 133, a detection unit 134, a central processing unit (CPU) 135, and a buffer unit 136. Wherein, the first USB controller and the second USB controller are designed according to a “user defined class” specified by Microsoft™, wherein the “user defined class” defines the connection protocol between devices.

The first USB controller 131 connects to the first connection interface 11 of the data transmission bridge device 1, such that when the first connection interface 11 is connected with a first host device 2, an inquire signal is produced for the first host device 2, and the first USB controller 131 wait for a response from the first host device 2, then complete the connection between the first connection interface 11 and the first host device 2, so that data transmission can proceed.

The second USB controller 132 couples to the first USB controller 132 and connects to the second connection interface 12 of the data transmission bridge device 1, such that when the second connection interface 12 is connected with a second host device 3, an inquire signal is produced for the second host device 3, then the second USB controller 132 complete the connection between the second connection interface 12 and the second host device 3, so that data transmission can proceed, thus the second USB controller 132 coupled with the first USB controller 131 forms a transmission bridge.

The bypass circuit unit 133 is connected between the first USB controller 131 and the second connection interface 12, such that when the second connection interface 12 is connected with a slave device 4, a direct connection between the first USB controller 131 and the second connection interface 12 can be made, so that the first USB controller 131 can response to an inquire signal produced by the slave device 4, and thus the first host device 2 and the slave device 4 can proceed with various host-slave device operations.

The Detection unit 134 is also connected to the second connection interface 12, and the detection unit 134 will automatically operate to switch between a virtual host state and a virtual slave state, wherein the states are used to determine the type of device currently connected with the second connection interface 12, and a detection signal (bridging detection signal or slave detection signal) is produced accordingly. On the other hand, the CPU 135 is for receiving the detection signal, and then according to the detection signal controls the operation of either the second USB controller 132 or the bypass circuit unit 133.

Therein, when the detection unit 134 switches to the virtual slave state, the detection unit 134 will produce an inquire signal to the device connected to the second connection interface 12, and after acquiring a response from the device connected to the second connection interface 12, the detection unit 134 will produce a bridging detection signal, which causes the CPU 135 to activate the second USB controller 132 for operation according to the bridging detection signal, and thus the connection between the second USB controller 132 and the first USB controller 131 is achieved.

On the other hand, when the detection unit 134 switches to the virtual host state, and also has received an inquire signal produced by the device connected to the second connection interface 12, the detection unit 134 will produce a slave detection signal, which causes the CPU 135 to activate the bypass circuit unit 133 for operation according to the slave detection signal. In other words, when the CPU 135 activates bypass circuit unit 133 for operation, the only controller inside the control chip 13 that is operational is the first USB controller 131, and the control chip 13 at this time functions like a USB Hub chip, merely acting with intermediate transmission function.

Furthermore the buffer unit 136 can connected between the first USB controller 131 and the second USB controller 132, for buffering and storing temporary data that passes between the two controllers. This way, data loss between the data transfer of first host device 2 and the second host device 3 can be avoided. As described above, the structural design of the control chip 13 is thus complete.

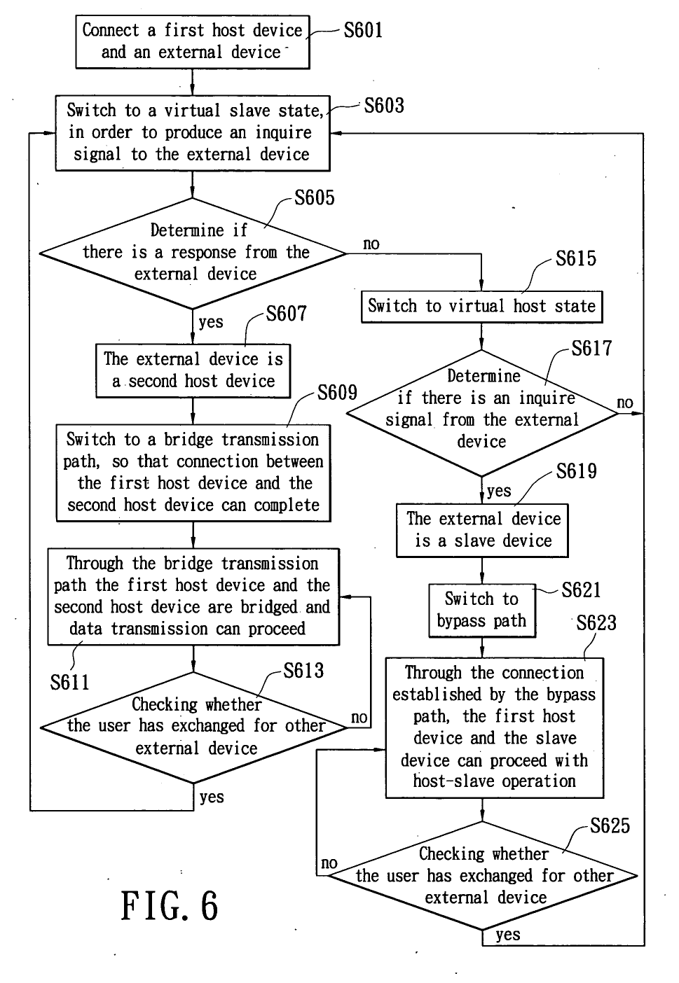

Please reference FIG. 6, which shows a method flow chart for a data transmission bridge device and control chip thereof for transmitting data according to the present invention. As shown by the figure, the present embodiment provides a method for data transmission bridging, the step includes: first, connect a first host device 2 and an external device (S601), so that the transmission of data between the first host device 2 and the external device may proceed.

Next, switch to a virtual slave state, in order to produce an inquire signal to the external device (S603), and then determine if there is a response from the external device (S605). If at step (S605) the answer is yes regarding the receiving of the external device response, then it is determined that the external device is a second host device 3 (S607), and at this time switch to a bridge transmission path, so that connection between the first host device 2 and the second host device 3 can complete (S609). Finally, through the bridge transmission path the first host device 2 and the second host device 3 are bridged and data transmission can proceed (S611). At the same time that bridged transmission is occurring, a further step of checking whether the user has exchanged for other external device would occur constantly (S613), if it is determined that there are no exchange for other external device, the bridged transmission of data between the first host device 2 and the second host device 3 will continue; however if the user has exchanged for other external device, then return to step (S603).

However if at (S605) the answer is no regarding the receiving of the external device response, then it is determined that the external device is not a host type device. Therefore, an automatic switch to virtual host state will occur (S615), and then further determine if there is an inquire signal from the external device (S617). At this time, if the answer is yes regarding the receiving of the external device inquire signal, then it is determined that the external device is a slave device 4 (S619), and a switch to a bypass path would occur (S621), so that through the connection established by the bypass path, the first host device 2 and the slave device 4 can directly proceed with host-slave operation (S623). Of course, after step (S623), there would be a step of checking whether the user has exchanged for other external device (S625) that is similar to the previous described step (S613), if it is determined that there are no exchange for other external device, the host-slave operation between the first host device 2 and the save device 4 will continue; however if the user has exchanged for other external device, then return to step (S603).

Additionally, if at the above described step (S617) the answer is no regarding the receiving of the external device inquire signal, thus it is determined that the external device is not a slave device, then return to step (S603), so that a switch can be made to virtual slave state, and the detection/determination of the external device type would continue. Thus, through the automatic switching between virtual slave state and virtual host state, a detection of whether the type of external device is the second host device 3 or slave device 4 can be made, which in turn the proper transmission path can be switched to accordingly, so that the data transmission between the first host device 2 and the external device is achieved.

As per described above, the present invention designed a data transmission bridge device, which by automatically detecting the type of connected device to switch between the proper transmission path, can not only support data transmission between a host device and a slave device, but can also directly support data transmission between two host devices, and because the design adheres to USB specification, so there is also the convenient “plug and play” characteristic. Thus, the objective of conveniently bridging between a host device and any other device for data transfer is achieved. Further more, because the two connected device would be transferring data directly, the design will attend high transfer efficiency.

While the invention has been described in terms of what is presently considered to be the most practical and preferred embodiments, it should be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A data transmission bridge device, which adopts USB specification for data transmission, comprising:
a first connection interface, connecting to a first host device;
a second connection interface, connecting to a second host device or a slave device; and
a control chip, connecting to the first connection interface and the second connection interface, and including two transmission paths, wherein the control chip is used for detecting the device connected with the second connection interface and accordingly switching to one of the two transmission paths to use for data transmission between the first connection interface and the second connection interface.

2. The data transmission bridge device as claimed in claim 1, wherein the data transmission bridge device can be designed as a USB bridge transmission line.

3. The data transmission bridge device as claimed in claim 2, wherein the second connection interface may be attached to an adapter, in order to transform the connector type of the second connection interface.

4. The data transmission bridge device as claimed in claim 2, wherein the second connection interface may be designed with an A-Type male connector and a B-Type male connector of the USB specification of dual connector type design.

5. The data transmission bridge device as claimed in claim 1, wherein the second connection interface is an A-Type female connector of the USB specification, and may be attached to a transmission extension cable for connecting to a second host device or a slave device.

6. The data transmission bridge device as claimed in claim 1, wherein the control chip is based on a “user defined class” for design, in order to comply with the connection protocol between the first host device and the second host device.

7. The data transmission bridge device as claimed in claim 1, wherein the control chip further includes a bridge transmission path and a bypass path.

8. The data transmission bridge device as claimed in claim 7, wherein the control chip will automatically switch between a virtual host state and a virtual slave state in regard to the second connection interface (meaning that it would appear to the device connected the second connection interface that the data transmission bridge device is a host or a slave, hence the term virtual host state and virtual slave state), and the two states are used to determine which type of device is connected with the second connection interface, so that the control chip can switch to the bridge transmission path or the bypass path accordingly.

9. The data transmission bridge device as claimed in claim 8, wherein when the control chip switches the second connection interface to the virtual host state and receives an inquire signal produced by the device connected to the second connection interface, then the control chip determines that the second connection interface is connected to a slave device, and switches to the bypass path in order to achieve connection between the first host device and the slave device so that a host-slave operation between the first host device and the slave device can proceed.

10. The data transmission bridge device as claimed in claim 9, wherein, when the control chip switches to the virtual slave state, and an inquire signal is produced by the control chip led to a corresponding response from the device connected to the second connection interface, then the control chip determines that the second connection interface is connected to the second host device, and proceed to switch to the bridge transmission path, in order to bridge the first host device and the second host device for data transmission.

11. The data transmission bridge device as claimed in claim 1, further comprising a memory unit, connected to the control chip, for storing the data required by the control chip while the control chip is operating.

12. A control chip for a data transmission bridge device, the data transmission bridge device comprising a first connection interface and a second connection interface, and the control chip comprising:
a first USB controller, connected to the first connection interface, and connecting with a first host device through the first connection interface for data transmission;
a second USB controller connected with the first USB controller and the second connection interface, whereby the second USB controller connects with the second host device through the second connection interface, thus forming a bridge for data transmission between the second host device and the first USB controller, when the second connection interface is connected to a second host device;
a bypass circuit unit, connected with the second connection interface, whereby the bypass circuit unit will directly connect to the first USB controller and the second connection interface, so that a host-slave operation between the first host device and the slave device can proceed, when the second connection interface is connected to a slave device.
a detection unit, which will automatically switch between a virtual host state and a virtual slave state, wherein the two states are used to determine the type of device connected with the second connection interface, and a detection signal is generated accordingly; and
a central processing unit (CPU), which will receive the detection signal, and according to the detection signal brings either the second USB controller or the bypass circuit unit into operation.

13. The control chip for a data transmission bridge device as claimed in claim 12, wherein the first USB controller and the second USB controller are both based on a “user defined class” for design, in order to comply with the connection protocol between the first host device and the second host device.

14. The control chip for a data transmission bridge device as claimed in claim 12, wherein when the detection unit switches to the virtual host state and has received an inquire signal produced by the device connected to the second connection interface, the detection unit will generate a slave detection signal, so that the CPU can activate the bypass circuit unit for operation according to the slave detection signal.

15. The control chip for data transmission bridge device as claimed in claim 14, wherein when the detection device switches to the virtual slave state and the detection unit generated an inquire signal which led to a response from the device connected to the second connection interface, then the detection unit will generate a bridging detection signal, so that the CPU can activate the second USB controller for operation according to the bridging detection signal.

16. The control chip for a data transmission bridge device as claimed in claim 12, further comprising a buffer unit connected between the first USB controller and the second USB controller, for buffering and temporarily storing the data transmitted between the two controllers.
